(19) United States
(12) Patent Application Publication
(10) Pub. No.: US 2021/0316622 A1
(43) Pub. Date: Oct. 14, 2021

(54) COIL UNIT, MOVING OBJECT, POWER RECEIVING DEVICE, AND WIRELESS POWER TRANSMISSION SYSTEM

(71) Applicant: TDK CORPORATION, Tokyo (JP)

(72) Inventors: Hiroshi KAMEYAMA, Tokyo (JP); Hideo ASANO, Tokyo (JP)

(73) Assignee: TDK CORPORATION, Tokyo (JP)

(21) Appl. No.: 17/225,220

(22) Filed: Apr. 8, 2021

(30) Foreign Application Priority Data
Apr. 10, 2020 (JP) 2020-070822

(51) Int. Cl. B60L 53/12; H02J 50/00; H02J 50/10

(52) U.S. Cl. CPC B60L 53/12; H02J 50/10; H02J 50/005

(57) ABSTRACT

A power receiving coil unit is installed on a moving object. The power receiving coil unit includes a power receiving coil, a housing that is made from a resin and that includes an accommodator that accommodates the power receiving coil, and a reinforcing member that is made from metal, is provided outward from the accommodator of the housing, and reinforces the housing.

### CROSS-REFERENCE TO RELATED APPLICATION

This application claims the benefit of Japanese Patent Application No. 2020-070822, filed on Apr. 10, 2020, the entire disclosure of which is incorporated by reference herein.

### FIELD

The present disclosure relates generally to a coil unit, a moving object, a power receiving device, and a wireless power transmission system.

### BACKGROUND

A wireless power transmission system for an electric vehicle includes, for example, a power transmission coil installed in a parking space, and a power receiving coil disposed on a lower surface of a floor of the electric vehicle. In such a system, electromagnetic induction causes power supply from the power transmission coil to the power receiving coil.

The power receiving coil is affected by the vibrations of the electric vehicle, heat, wind and rain, and the like. As such, the power receiving coil is placed in a casing and disposed on the lower surface of the floor of the electric vehicle. The casing is formed from a synthetic resin so as not to impede the electromagnetic induction.

However, casings formed from synthetic resin have low rigidity and, consequently, easily twist when attached to the electric vehicle. For example, twisting may occur in the casing due to the tolerance of the lower surface of the floor of the electric vehicle and the molding tolerance of the casing, or twisting may occur due to twisting forces acting on the casing due to vibration when traveling of the electric vehicle. Such twist deformation may lead to reductions in sealability, deterioration of fastening strength, and the like.

As a solution to this problem, Unexamined Japanese Patent Application Publication No. 2014-127592 proposes a casing for a power receiving coil, the casing including a base plate that is made from a metal and that has high rigidity, and a top cover made from a synthetic resin.

In the configuration disclosed in Unexamined Japanese Patent Application Publication No. 2014-127592, the base plate is formed from a metal. As such, there is a problem in that the base plate is higher in weight than a base plate formed from a resin.

### SUMMARY

A coil unit according to the present disclosure that solves the problems described above is

a coil unit to be installed on a moving object, the coil unit including:

a coil;

a housing that is made from a resin and that includes an accommodator that accommodates the coil; and

a member that is made from a metal and that is provided at at least a portion of the housing outward from the accommodator.

A moving object according to the present disclosure includes a metal plate on a bottom surface of the moving object, and the coil unit installed on the metal plate.

A power receiving device according to the present disclosure includes a power receiving circuit into which voltage generated in the coil of the coil unit is input.

A wireless power transmission system according to the present disclosure includes the power receiving device, and a power transmission device that transmits power to the power receiving device.

### BRIEF DESCRIPTION OF THE DRAWINGS

A more complete understanding of this application can be obtained when the following detailed description is considered in conjunction with the following drawings, in which:

FIG. 1 is a schematic drawing schematically illustrating configuration of a power transmission system according to Embodiment 1;

FIG. 2 is a perspective view schematically illustrating a power transmission coil unit and a power receiving coil unit according to Embodiment 1;

FIG. 3 is a side view schematically illustrating a state in which the power receiving coil unit according to Embodiment 1 is attached to an electric vehicle;

FIG. 4 is an exploded perspective view illustrating configuration of a casing of the power receiving coil unit according to Embodiment 1;

FIG. 5 is a cross-sectional view illustrating a cross-section taken along line V-V of FIG. 4;

FIG. 6 is an enlarged view illustrating a cross-sectional size of a reinforcing member illustrated in FIG. 5;

FIG. 7A is a disassembled view illustrating the structure of the power receiving coil unit according to Embodiment 1;

FIG. 7B is a cross-sectional view illustrating a structure of the power receiving coil unit according to Embodiment 1;

FIG. 7C is a perspective view of an inner casing illustrated in FIG. 7A;

FIG. 8 is a cross-sectional view illustrating positions of the power receiving coil, a ferrite structure, and the reinforcing member, that are included in the power receiving coil unit according to Embodiment 1;

FIG. 9 is a cross-sectional view illustrating a connection member provided in the reinforcing member of the power receiving coil unit according to Embodiment 1;

FIG. 10A is a cross-sectional view illustrating a modified example of the reinforcing member according to Embodiment 1, in which the reinforcing member includes a bead-like part;

FIG. 10B is a perspective view illustrating the reinforcing member of FIG. 10A;

FIG. 11 is a cross-sectional view of a modified example of the reinforcing member according to Embodiment 1;

FIG. 12A is a cross-sectional view of another modified example of the reinforcing member according to Embodiment 1;

FIG. 12B is a perspective view of the another modified example of the reinforcing member according to Embodiment 1;

FIG. 13A is a disassembled perspective view of a casing according to Embodiment 2;

FIG. 13B is a cross-sectional view taken along line B-B of FIG. 13A;

FIG. 14A is a disassembled perspective view of a casing according to a modified example of Embodiment 2;

FIG. 14B is a cross-sectional view taken along line B-B of FIG. 14A; and

FIG. 15 is a plan view of a reinforcing member according to a modified example of Embodiment 2.

### DETAILED DESCRIPTION

Hereinafter, a power transmission system and a coil unit according to embodiments are described with reference to the drawings. In the following embodiments, identical constituents are assigned the same reference numeral. Additionally, the size ratios and shapes of the constituents illustrated in each drawing, and the relative positional relationships between the constituents may differ from actual ones.

### EMBODIMENT 1

The wireless power transmission system according to the present embodiment can be used to charge secondary batteries of various types of moving objects such as electric vehicles, hybrid vehicles, and the like. In the following, a wireless power transmission system that charges a storage battery of an electric vehicle that is an example of the moving object is described as an example of the wireless power transmission system.

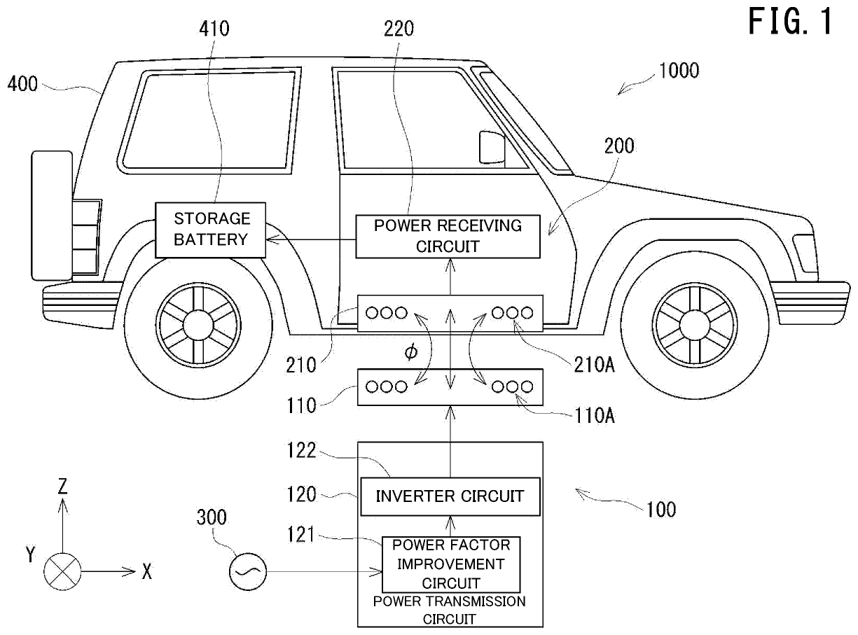

FIG. 1 is a schematic drawing illustrating configuration of a power transmission system 1000 that charges a storage battery 410 mounted on an electric vehicle 400. The electric vehicle 400 is driven by power stored in the storage battery 410 that is a lithium-ion battery, a lead-acid battery, or the like.

The power transmission system 1000 is a system in which power is wirelessly transmitted from a power transmission device 100 to a power receiving device 200 by magnetic coupling. In one example, the power transmission device 100 is fixed to the floor or ground of a parking space. The power receiving device 200 is mounted on the electric vehicle 400.

Firstly, the power transmission device 100 is described. The power transmission device 100 is a device that wirelessly transmits power to the power receiving device 200 by magnetic coupling. The power transmission device 100 includes a power transmission coil unit 110 including a power transmission coil 110A that generates magnetic flux, and a power transmission circuit 120 that supplies current to the power transmission coil 110A of the power transmission coil unit 110. In one example, the power transmission circuit 120 includes a power factor improvement circuit 121 that converts AC voltage output from a commercial power supply 300 to DC voltage, and an inverter circuit 122 that generates desired AC voltage from the DC voltage generated by the power factor improvement circuit 121.

The power factor improvement circuit 121 converts the AC voltage output from the commercial power supply 300 to DC voltage and, also, improves a power factor of the power transmission device 100 as a load. In one example, the power factor improvement circuit 121 includes a diode bridge circuit including a plurality of diodes, a capacitor that smooths the voltage output by the diode bridge circuit, an inductor that reduces a high-frequency component of the voltage output by the diode bridge circuit, a transistor that adjusts a phase difference between AC voltage and AC current, a diode that suppresses backflow of the current, and an electrolytic capacitor that smooths the voltage output to the inverter circuit 122.

The inverter circuit 122 converts the DC voltage output from the power factor improvement circuit 121 to AC voltage. The frequency of the AC voltage generated by the inverter circuit 122 is from 75 kHz to 90 kHz, for example. In one example, the inverter circuit 122 includes a full bridge circuit including a plurality of power transistors.

Next, the power receiving device 200 is described. The power receiving device 200 is a device that wirelessly receives power from the power transmission device 100 by magnetic coupling. The power receiving device 200 includes a power receiving coil unit 210 including a power receiving coil 210A that generates voltage (electromotive force) in response to changes in magnetic flux density, and a power receiving circuit 220 into which voltage output from the power receiving coil 210A of the power receiving coil unit 210 is input.

The power receiving circuit 220 includes a rectifier circuit that rectifies AC voltage output from the power receiving coil 210A to generate DC voltage. The DC voltage generated by the rectifier circuit is applied to the storage battery 410. The power receiving circuit 220 may include a voltage conversion circuit that converts the DC voltage output from the rectifier circuit to DC voltage suitable for charging the storage battery 410.

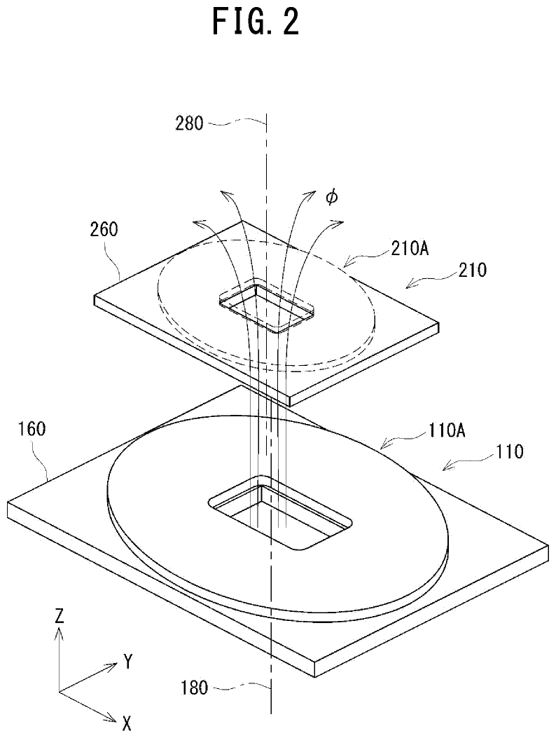

Next, the power transmission coil unit 110 included in the power transmission device 100 and the power receiving coil unit 210 included the power receiving device 200 are described with reference to FIG. 2. FIG. 2 is a perspective view schematically illustrating the power transmission coil unit 110 and the power receiving coil unit 210.

The power transmission coil unit 110 includes at least the power transmission coil 110A, and a magnetic member that is disposed opposite the power transmission coil 110A and that is formed from a magnetic body. In the present embodiment, the magnetic member is implemented as a ferrite structure 160 including a plurality of ferrite members. The AC voltage generated by the inverter circuit 122 illustrated in FIG. 1 is applied to the power transmission coil 110A, and the AC current flows through the power transmission coil 110A. Alternating magnetic flux ϕ is induced by the AC current flowing through the power transmission coil 110A.

The power receiving coil unit 210 includes at least the power receiving coil 210A, and a magnetic member disposed opposite the power receiving coil 210A. In the present embodiment, the magnetic member is implemented as a ferrite structure 260 including a plurality of ferrite members. The ferrite structure 260 is an example of the magnetic member of the power receiving coil 210A. Induced electromotive force is generated in the power receiving coil 210A in response to changes in the alternating magnetic flux 41).

The power transmission coil 110A and the power receiving coil 210A are disposed so as to face each other at a time of charging the storage battery 410. At such a time, it is preferable that a center axis 180 of the power transmission coil 110A and a center axis 280 of the power receiving coil 210A overlap. The ferrite structures 160 and 260 are disposed so as to sandwich the power transmission coil 110A and the power receiving coil 210A.

Induced electromotive force is generated in the power receiving coil 210A due to the alternating magnetic flux 1 induced by the power transmission coil 110A interlinking with the power receiving coil 210A. Power is wirelessly transmitted, on the basis of this law of electromagnetic induction, from the power transmission coil 110A to the power receiving coil 210A.

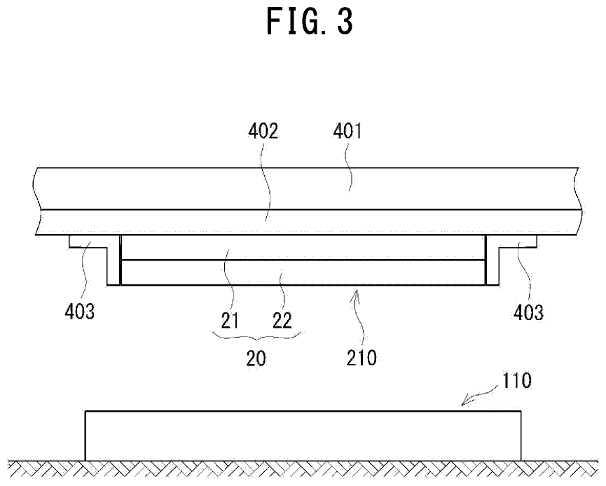

Next, the power receiving coil unit 210 is described with reference to FIGS. 3 to 5.

As schematically illustrated in FIG. 3, the power receiving coil unit 210 is fixed, via a shielding plate 402, to a bottom surface 401 of the electric vehicle 400 by a fixer 403. The shielding plate 402 is formed from a metal such as aluminum or from a conductor, and prevents the magnetic flux generated by the power transmission coil 110A and the power receiving coil 210A from entering into the compartment of the electric vehicle 400. The shielding plate 402 is an example of the metal plate.

In one example, the power transmission coil unit 110 is installed at a position that is to be opposite, when the electric vehicle 400 is parked, the power receiving coil unit 210.

The power receiving coil unit 210 includes a housing 20 that houses the power receiving coil 210A and the ferrite structure 260.

The housing 20 includes a casing 21 and a top cover 22.

The casing 21 is fixed to the bottom surface 401 of the electric vehicle 400 via the shielding plate 402 of FIG. 3, and the top cover 22 covers an opening of the casing 21. In the present embodiment, the shielding plate 402 is provided on the bottom surface 401 of the electric vehicle 400 and, as such, the shielding plate 402 can sufficiently shield from leakage of the magnetic flux generated by the power transmission coil 110A and the power receiving coil 210A. As such, from the standpoint of shielding, the casing 21 of the power receiving coil unit 210 need not be made of metal.

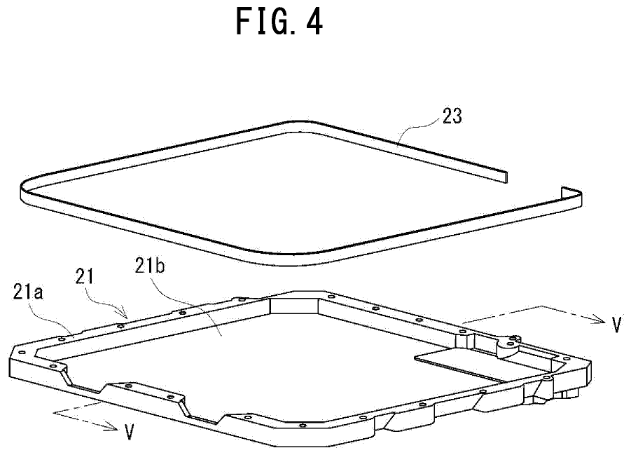

As illustrated in FIG. 4, the casing 21 has a rectangular shape when viewed from above, has a wall 21a on a periphery thereof, and has a recess in a center section thereof. The recess constitutes an accommodator 21b that accommodates a portion of the power receiving coil unit 210. The casing 21 is formed from a synthetic resin. A non-illustrated bottom surface of the casing 21 is formed flat, for attachment to the electric vehicle 400. In the casing 21, a groove is provided through which a wire is led out from the interior of the power receiving coil unit 210 in order to connect the power receiving coil 210A to a device outside the power receiving coil unit 210.

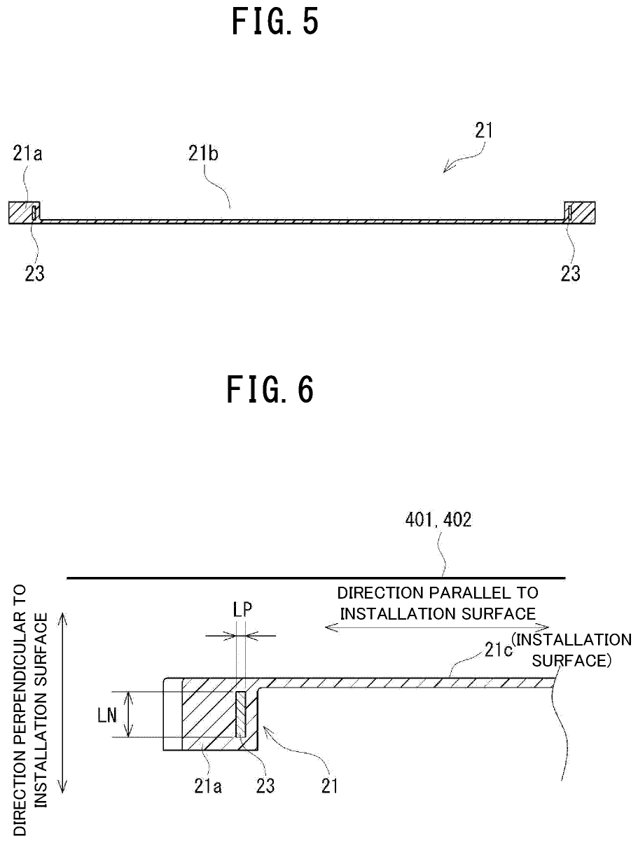

FIG. 5 illustrates a cross-sectional view taken along line V-V of FIG. 4. As described above, the casing 21 has the wall 21a on the periphery thereof, and has, in the center section thereof, the recess constituting the accommodator 21b that accommodates the power receiving coil 210A and the ferrite structure 260. Additionally, a plurality of fasteners is formed on the wall 21a of the casing 21 illustrated in FIG. 4. The casing 21 and the top cover 22 are fastened to each other and integrated by this plurality of fasteners.

The wall 21a is formed relatively thick, and a reinforcing member 23 is embedded in the wall 21a. The reinforcing member 23 is formed from a material that is higher in rigidity than the synthetic plastic forming the casing 21. Examples of the material include a metal such as aluminum, copper, and the like. The reinforcing member 23 is a type of frame member that is disposed at a position outward from the accommodator 21b. In the present embodiment, the reinforcing member 23 is disposed in the wall 21a. As illustrated in FIG. 4, the reinforcing member 23 is formed in a “C” shape, and penetrates the wall 21a of the casing 21 along the periphery of the accommodator 21b roughly one time around. In other words, the reinforcing member 23 has a “C” shape forming a partially open ring and surrounding the accommodator 21b. The reinforcing member 23 has a function of reinforcing the casing 21 to increase the rigidity, particularly the torsional rigidity, of the housing 20. The reinforcing member 23 is an example of a first member.

From the standpoint of increasing torsional rigidity, reinforcing members 23 that are thick and large are preferable. However, as the reinforcing member 23 becomes thicker and larger, the weight thereof increases, which is unpreferable from the standpoint of reducing the weight of the power receiving coil unit 210. Therefore, in order to efficiently increase the torsional rigidity, employment of the configuration as illustrated in FIG. 6 is preferable in which a length LN in a direction perpendicular to an installation surface 21c is greater than a width LP in a direction parallel to the installation surface 21c of the casing 21, that is, LN>LP. Here, the installation surface 21c is the outer surface (the top surface in FIG. 6) of the casing 21 that faces the bottom surface of the electric vehicle 400 when the casing 21 is installed on the electric vehicle 400.

The reinforcing member 23 is embedded in the wall 21a by performing insert molding performing resin molding of the casing 21. As a result, the reinforcing member 23 is integrated with the surrounding synthetic resin, thereby improving the torsional rigidity of the housing 20.

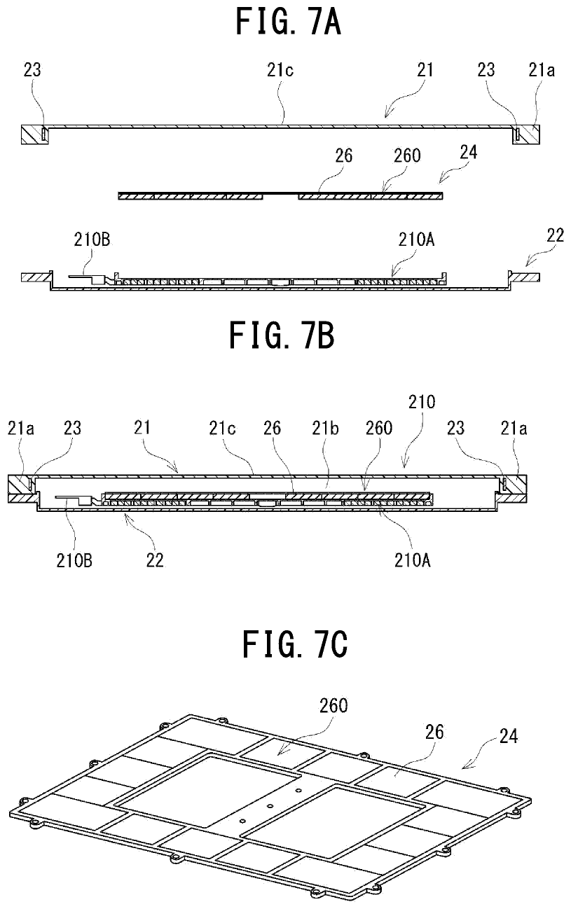

As illustrated in FIG. 7A, the casing 21 is fixed to the electric vehicle 400 in a state in which the recess is open downward. An inner casing 24 is disposed in the casing 21, the top cover 22 is overlaid on the casing 21, and the fasteners on the periphery are fastened and fixed to each other by screws or the like. As a result, the power receiving coil unit 210 having the cross-section illustrated in FIG. 7B is formed.

As illustrated in FIG. 7C, the inner casing 24 is a pallet-like flat member that is partitioned into small regions. A plate-like ferrite member 26 is disposed in each of the partitioned small regions. A plurality of the ferrite members 26 constitutes the ferrite structure 260.

As illustrated in FIG. 7A, the power receiving coil 210A includes a bobbin on which a lead wire is fixed, and is formed by winding the lead wire on the bobbin in a spiral manner. The bobbin may be provided with an accommodator that accommodates the lead wire of the power receiving coil 210A. The bobbin to which the power receiving coil 210A is fixed is laminated on the inner casing 24 on which the ferrite members 26 are disposed. As a result, the power receiving coil 210A and the ferrite structure 260 are integrated. The top cover 22 closes the opening of the casing 21. The recess of the casing 21 and the recess of the top cover 22 form the housing 20 that includes the accommodator 21b that accommodates the power receiving coil 210A and the ferrite structure 260. In FIGS. 7A and 7B, wiring for leading an end 210B of the lead wire of the power receiving coil 210A out of the power receiving coil unit 210 is not illustrated.

The reinforcing member 23 is formed of a metal such as aluminum, copper, or the like. As such, an eddy current may be generated when the alternating magnetic flux ϕ interlinks with the reinforcing member 23, and thus energy may be wasted.

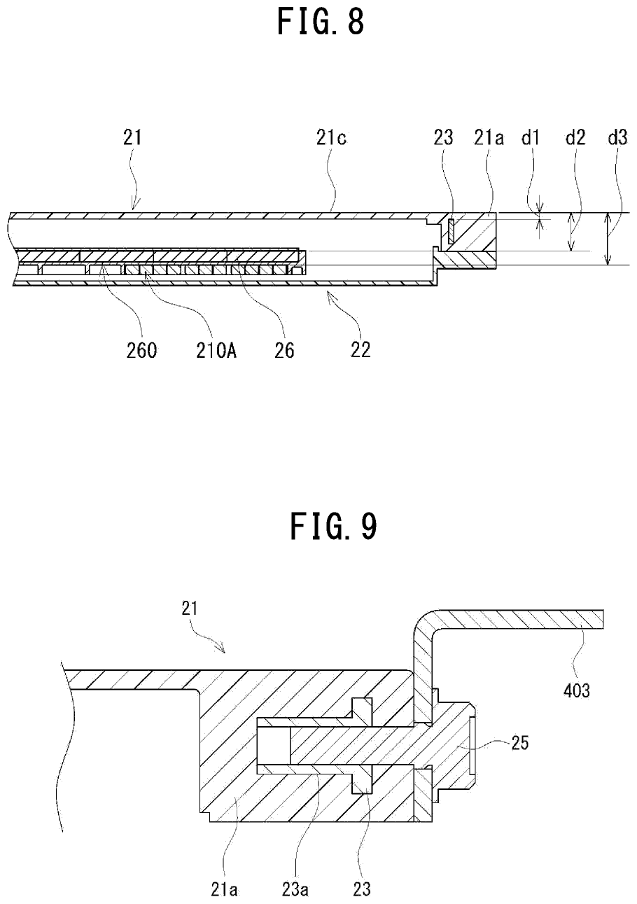

In order to prevent such a situation, the reinforcing member 23 is disposed outward from the accommodator 21b, that is, outward in the direction parallel to the installation surface 21c of the casing 21 with respect to the accommodator 21b. Additionally, it is preferable that the reinforcing member 23 is closer to the installation surface 21c of the casing 21 than the power receiving coil 210A, as illustrated in FIG. 8. Furthermore, it is preferable that the reinforcing member 23 is closer to the installation surface 21c of the casing 21 than the ferrite structure 260. Additionally, it is preferable that the ferrite structure 260 is disposed at a position between the power receiving coil 210A and the installation surface 21c of the casing 21 and, furthermore, between the reinforcing member 23 and the power receiving coil 210A. FIG. 8 illustrates an example in which a distance d3 from the installation surface 21c to the power receiving coil 210A, a distance d2 from the installation surface 21c to the ferrite structure 260, and a distance d1 from the installation surface 21c to the reinforcing member 23 have a relationship of d3>d2>d1, which is the most preferable example. In other words, it is preferable that the power receiving coil 210A is the closest, the ferrite structure 260 is the next closest, and the reinforcing member 23 is the next closest to the power transmission coil unit 110.

Additionally, it is preferable that a portion of the reinforcing member 23 is provided with a connection member 23a for fixing the casing 21 to an external device, that is, in the present embodiment, for fixing the casing 21 to the electric vehicle 400. FIG. 9 illustrates an example of the above configuration, in which a female screw is formed as the connection member 23a in a portion of the reinforcing member 23.

The reinforcing member 23 has a female screw forming portion that is thicker in the thickness LP than the other portions thereof, and a female screw is formed at the female screw forming portion. A screw hole that communicates with the outside is formed in the female screw. The casing 21 can be fixed to the electric vehicle 400 by screwing a bolt 25 into the female screw and fixing the fixer 403. The female screw as the connection member 23a may be formed by machining the metal body constituting the reinforcing member 23, or may be formed by attaching to the reinforcing member 23 a female screw formed by machining metal.

As described above, according to the present embodiment, the casing 21 is formed from a resin. This enables the casing 21 that is low in weight than in a case in which the casing 21 includes a metal base plate and a resin cover. The metal reinforcing member 23 is embedded in a “C” shape in the wall 21a of the casing 21. Due to this, the entire casing 21 can obtain high torsional rigidity. Therefore, even if manufacturing tolerance of the electric vehicle 400, mounting error when attaching the housing 20 to the electric vehicle 400, distortion of the electric vehicle 400, or the like occurs, or even if twisting forces act on the housing 20 due to vibration when traveling of the electric vehicle 400, twisting deformation of the housing 20 itself is less likely to occur, and the power receiving coil 210A and the ferrite structure 260 provided in the casing 21 can be protected.

### MODIFIED EXAMPLE 1

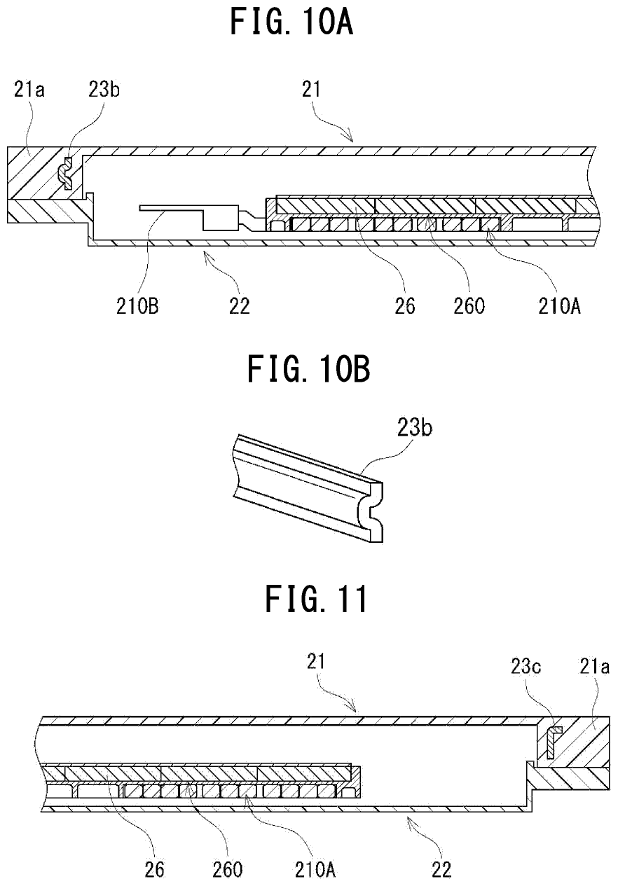

In the aforementioned embodiment, the reinforcing member 23 has a plate-like (or an “I” shaped) cross-sectional shape. Forming a bent section in the cross-sectional shape enables to obtain higher torsional rigidity without increasing the weight. High torsional rigidity can be obtained by, for example, employing a reinforcing member 23b as illustrated in FIGS. 10A and 10B that is provided with a bead to form a 90 degree-rotated “V” cross-sectional shape or by employing a reinforcing member 23c as illustrated in FIG. 11 that has a portion bent at a right angle to form an “L” cross-sectional shape. In addition, forming a 90 degree-rotated “U”, “C”, “H”, or similar cross-sectional shape enables to obtain high torsional rigidity without changing the weight. In FIG. 10A, the wiring for leading the end 210B of the lead wire of the power receiving coil 210A out of the power receiving coil unit 210 is not illustrated.

### MODIFIED EXAMPLE 2

In the aforementioned embodiment, the reinforcing member 23 is incorporated into the casing 21 by performing insert molding. However, the present disclosure is not limited thereto, and a configuration may be employed in which a groove for insertion of the reinforcing member 23 is formed in the casing 21 and, after molding the casing 21, the reinforcing member 23 is incorporated into the groove.

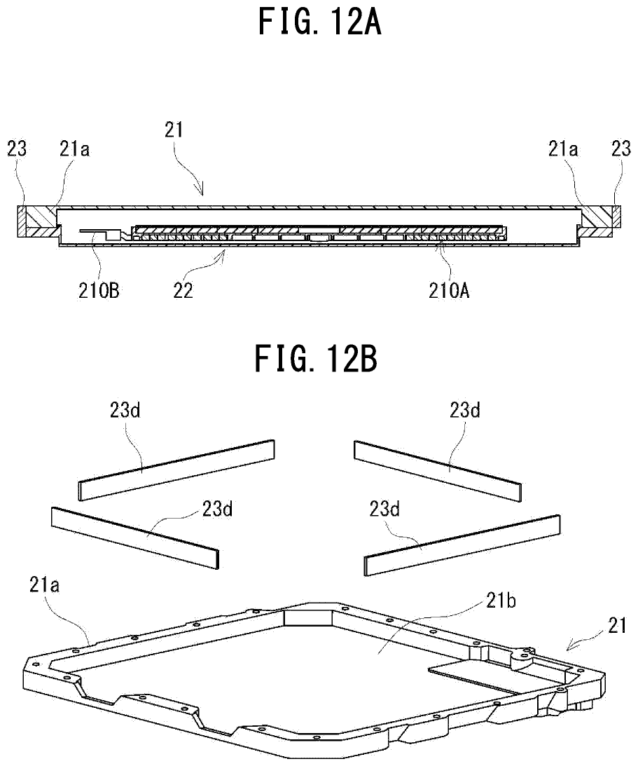

Furthermore, the reinforcing member 23 is not necessarily be embedded in the casing 21. For example, the reinforcing member 23 may be affixed or retrofitted outward from the accommodator 21b of the casing 21 (or the housing 20). For example, in FIG. 12A, a reinforcing member 23 that is made of metal and that has a plate-like cross-sectional shape is disposed around the wall 21a of the casing 21 (the right-side section in the drawing) or around the joint between the casing 21 and the top cover 22 (the left-side section in the drawing). Such a configuration enables improvement in the torsional rigidity of the housing 20. In FIG. 12A, the wiring for leading the end 210B of the lead wire of the power receiving coil 210A out of the power receiving coil unit 210 is not illustrated.

### MODIFIED EXAMPLE 3

In the aforementioned embodiment, an example is described in which a reinforcing member 23 that extends in a “C” shape is provided. However, the shape and the structure of the reinforcing member 23 are not limited thereto. For example, a configuration may be employed in which, as illustrated in FIG. 12B, four linear reinforcing members 23d are disposed on the four sides of the wall 21a of the casing 21. Each reinforcing member 23d extends linearly along the periphery of the accommodator 21b, for example, extends linearly inside the wall 21a. A casing that has high torsional rigidity can be obtained by embedding the linear reinforcing members 23d in the wall 21a or by affixing the linear reinforcing members 23d to the wall 21a. Note that a configuration may be employed in which one to three reinforcing members 23d are disposed on one to three sides of the wall 21a. Such configuration also enables increase in the torsional rigidity. Additionally, a connection member such as a female screw may be disposed on one or all of the reinforcing members 23. Furthermore, the cross-sectional shape of each reinforcing member 23d may be configured in a shape having high rigidity by inclusion of a bent section, such as the example shapes illustrated in FIGS. 10A, 10B, and 11. The reinforcing members 23d may have different cross-sectional shapes.

### EMBODIMENT 2

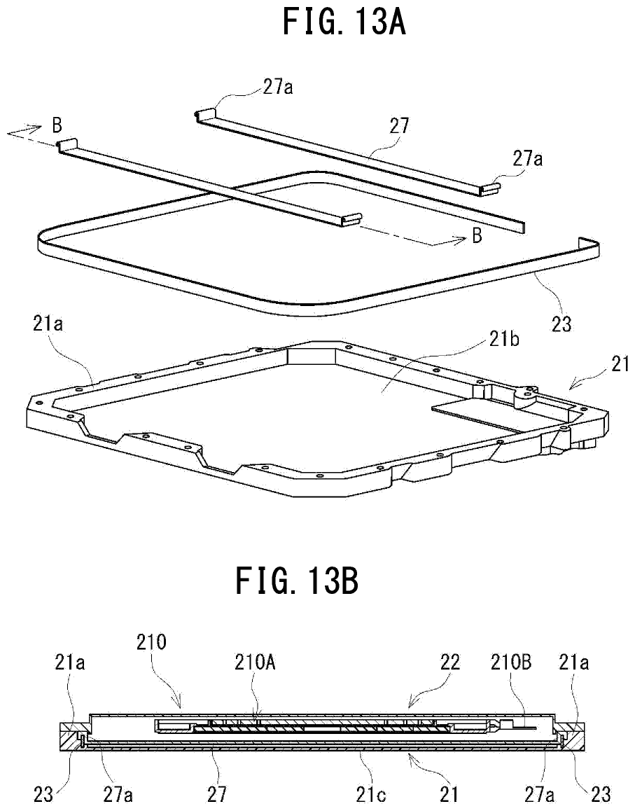

In Embodiment 1, an example is described in which, in order to increase the torsional rigidity of the housing 20, a reinforcing member is disposed at the wall 21a of the casing 21, along the periphery of the accommodator 21b. Depending on the use situation of the power receiving coil unit 210, surface rigidity of the casing 21 may be required. In such situation, a reinforcing member 27 may be disposed, as illustrated in FIG. 13A. The reinforcing member 27 is a type of beam member that extends parallel to the installation surface 21c in a region overlapping the accommodator 21b. The reinforcing member 27 increases surface rigidity of the casing 21 by suppressing fluctuation of the spacing between two opposite sides of the wall 21a of the casing 21. In the present embodiment, two linear reinforcing members 27 that extend parallel to each other are provided and, as illustrated in FIG. 13B, each reinforcing member 27 extends in the bottom surface of the casing 21 and has a structure in which the ends 27a thereof are bent to approximately 90 degrees so as to enter into the wall 21a. In one example, the reinforcing members 27 are molded by the insert molding to be performed for molding the casing 21 from the synthetic resin. The reinforcing member 27 is an example of a second member. In FIG. 13B, the wiring for leading the end 210B of the lead wire of the power receiving coil 210A out of the power receiving coil unit 210 is not illustrated.

The rigidity of the housing 20 can be further increased by bringing the frame-like reinforcing member 23 and the beam-like reinforcing members 27 into contact with each other or fixing the frame-like reinforcing member 23 and the beam-like reinforcing members 27 to each other, as illustrated in FIG. 13B.

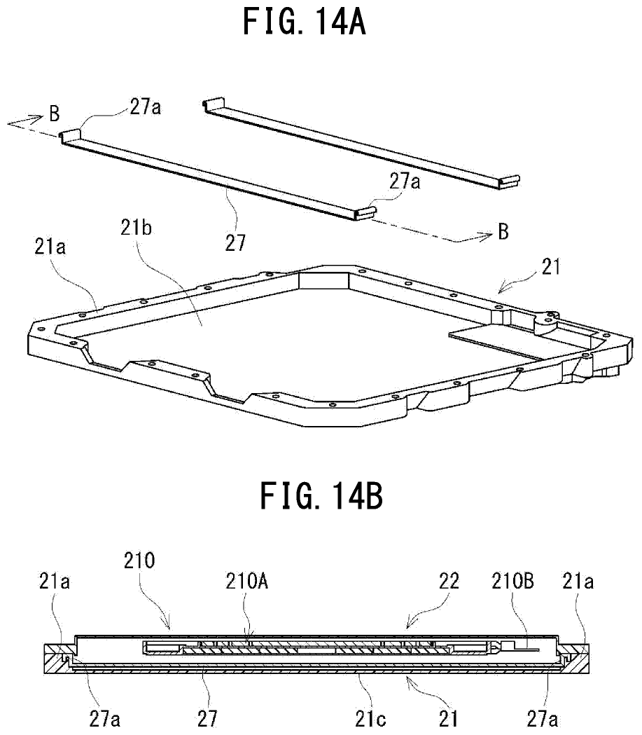

FIGS. 13A and 13B illustrate a configuration in which the reinforcing members 27 are disposed in addition to the reinforcing member 23. However, a configuration as illustrated in FIG. 14A may be employed in which the reinforcing member 23 is not disposed and only the reinforcing members 27 are disposed. In such a configuration, the reinforcing member 23 is not embedded in the wall 21a of the casing 21, as illustrated in FIG. 14B. However, each reinforcing member 27 extends in the bottom surface of the casing 21 and has the structure in which the ends 27a thereof enter into the wall 21a. In FIG. 14B, the wiring for leading the end 210B of the lead wire of the power receiving coil 210A out of the power receiving coil unit 210 is not illustrated.

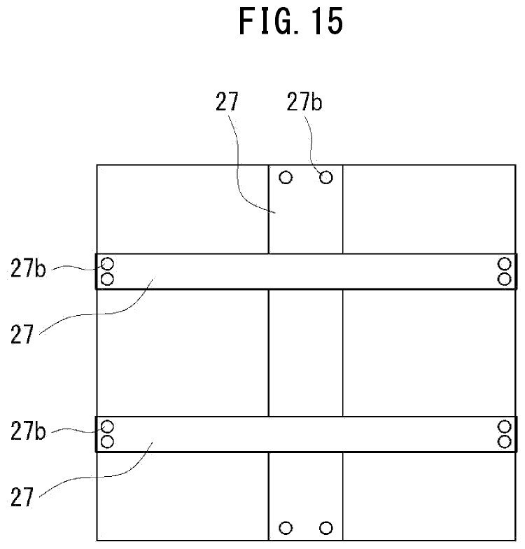

The structure of the reinforcing members 27 may also be changed, as appropriate. In FIGS. 13 and 14, an example is illustrated in which two opposite sides of the wall 21a of the casing 21 are connected by the reinforcing members 27. However a configuration as illustrated in FIG. 15 may be employed in which two sets of opposite sides of the wall 21a of the casing 21 are connected by the reinforcing members 27. Additionally, the configurations of the reinforcing members 27 may differ from each other. Furthermore, any technique that can fix the reinforcing members 27 to the wall 21a may be used. In FIG. 15, an example is illustrated in which a portion of the reinforcing members 27 is fixed to the casing 21 by screws 27b.

An example is described in which a magnetic body core of the power receiving coil 210A is implemented by the ferrite structure 260 that is formed from the plurality of ferrite members 26 accommodated in the inner casing 24. However, the ferrite structure 260 may have any structure. For example, the ferrite structure 260 may be laminated. Additionally, the planar shape and/or size of the ferrite structure 260 may be made to differ from layer to layer. Moreover, the ferrite structure 260 may be formed from a magnetic material other than ferrite. Furthermore, the magnetic member is not an essential constituent, and an air-core coil may be used.

### Other Modified Examples

Embodiments of the present disclosure are described above. However, various modifications and applications may be made when implementing the present disclosure. For example, although the aforementioned embodiments describe examples in which the casing 21 has a rectangular shape when viewed from above, no particular limitation is placed on the shape of the casing 21, and the casing 21 may have a circular shape, oval shape, or polygonal shape such as a hexagonal shape, when viewed from above. In the present disclosure, any part of the configurations, functions, and operations described in the aforementioned embodiments may be optionally adopted. Additionally, in the present disclosure, an additional configuration, function, or operation other than the configurations, functions, and operations described above may be adopted. Furthermore, the aforementioned embodiments may be combined as appropriate. Moreover, the numbers of the constituents in the aforementioned embodiments can be adjusted, as appropriate. Additionally, the materials, sizes, electrical characteristics, and the like usable in the present disclosure are not limited to those mentioned in the aforementioned embodiments.

In the description above, an example is described in which the present disclosure is applied to a wireless power transmission system for charging a storage battery of a vehicle. However, the application of the present disclosure is not limited thereto. For example, a similar configuration may be adopted for a case in which there is a possibility of twisting deformation occurring in the power transmission coil unit 110.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A coil unit to be installed on a moving object, the coil unit comprising:
a coil;
a housing that is made from a resin and that includes an accommodator that accommodates the coil; and
a member that is made from a metal and that is provided at at least a portion of the housing outward from the accommodator.

2. The coil unit according to claim 1, wherein the member is embedded in the resin that constitutes the housing.

3. The coil unit according to claim 1, wherein the member is closer to an installation surface of the housing than the coil.

4. The coil unit according to claim 1, further comprising:
a magnetic member disposed between the coil and an installation surface of the housing, wherein
the member is closer to an installation surface of the housing than the magnetic member.

5. The coil unit according to claim 1, wherein the member includes a first member extending along a periphery of the accommodator.

6. The coil unit according to claim 5, wherein the first member has a C shape surrounding the accommodator.

7. The coil unit according to claim 5, wherein a plurality of the first members is provided.

8. The coil unit according to claim 1, wherein the member has, when viewed in a cross-section taken along a surface orthogonal to the installation surface of the housing and to a direction in which the member extends, a length in a direction orthogonal to the installation surface that is longer than a length of the member in a direction parallel to the installation surface.

9. The coil unit according to claim 1, wherein the member includes a bent section that is bent in a cross-sectional view of the member taken along a surface orthogonal to a direction in which the member extends.

10. The coil unit according to claim 1, wherein the member includes a connection member for connection to an external device.

11. The coil unit according to claim 1, wherein the member includes a second member extending in a region that overlaps the accommodator of the housing.

12. The coil unit according to claim 11, wherein the second member is closer to the installation surface of the housing than the coil and has a shape that extends in a direction parallel to the installation surface.

13. The coil unit according to claim 11, wherein a plurality of the second members is provided.

14. A moving object, comprising:
a metal plate on a bottom surface of the moving object; and
the coil unit according to claim 1 installed on the metal plate.

15. A power receiving device, comprising:
the coil unit according to claim 1; and
a power receiving circuit into which voltage generated in the coil of the coil unit is input.

16. A wireless power transmission system, comprising:
the power receiving device according to claim 15; and
a power transmission device that transmits power to the power receiving device.
